(19) United States
(12) Patent Application Publication
(10) Pub. No.: US 2011/0302278 A1
(43) Pub. Date: Dec. 8, 2011

(54) METHOD FOR REMOTE WAKE-UP A COMPUTER CONNECTED TO A NETWORK

(75) Inventor: Jae Bum Shim, Seoul (KR)

(73) Assignee: LOGICPLANT, Seoul (KR)

(21) Appl. No.: 12/988,036

(22) PCT Filed: Feb. 22, 2008
(86) PCT No.: PCT/KR2008/001040

§ 371 Date: Mar. 27, 2011

(51) Int. Cl. G06F 15/16

(52) U.S. Cl. 709/219

(57) ABSTRACT

Provided is a method of remote wake-up of a computer connected to a network, using wake-up packet pattern settings. The method ensures that the computer is not waked-up by an unnecessary packet transmitted through the network during a sleep mode so as to be maintained to be in the sleep mode, and is waked-up by a terminal connected to the network when a user wants to wake-up the computer. Using the method, a wake-up packet pattern is defined in order to prevent the computer from being waked-up by an unnecessary packet transmitted through the network, and the computer enters the sleep mode again even if the computer is inevitably waked-up due to an operating manner of the network.

### TECHNICAL FIELD

The present invention relates to a method for remote wake-up of a computer connected to a network, using wake-up packet pattern settings.

### BACKGROUND ART

A computer, which has a network adapter installed therein and supporting wake-up LAN (WOL) and supports an advanced configuration and power interface (ACPI), may be set to be waked-up when receiving a magic packet or a wake-up packet through a network during a sleep mode for low power consumption. A pattern of the wake-up packet can be defined. In this regard, examples of the wake-up packet whose pattern is set to have a default value may include a unicast packet, an address resolution protocol (ARP) request packet for obtaining a device address, and a NetBIOS name query packet.

During a sleep mode of a computer having the default value as a pattern of a wake-up packet, when a unicast packet, an ARP request packet for obtaining a device address, and a NetBIOS name query packet are transmitted through a network, the computer is waked-up from the sleep mode. This function helps a computer to normally perform its function on a network. However, a computer may be waked-up at a point of time that is not desired or predicted by a user, and thus low power consumption may not be achieved.

To prevent such an occurrence, a computer may be set to be waked-up only by a magic packet except for a wake-up packet, or may be set not to be waked-up by any packet, and thus a sleep mode can be stably maintained. However, since the computer cannot provide information to other devices so that the devices may not keep recognizing or may not newly recognize the existence of the computer, as time passes, the computer cannot access any environment except for a significantly restrictive LAN environment, and the computer cannot be waked-up through a network by remote control. This is because an interactive communication protocol between the computer and its surrounding network devices does not sufficiently consider the computer that enters a sleep mode, in order to achieve lower power consumption.

### DISCLOSURE OF INVENTION

### Technical Problem

The present invention provides a method for remote wake-up, which prevents a computer connected to a network from being waked-up by an unnecessary packet event transmitted through the network, and performs remote wake-up of the computer by a remote terminal connected to the network when a user wants to wake up the computer.

### Technical Solution

According to an aspect of the present invention, there is provided a method for remote wake-up of a computer connected to a network, the method including defining a wake-up packet pattern that simultaneously satisfies maintenance of the sleep mode and remote wake-up; registering the wake-up pattern in a target computer; and transmitting the wake-up packet pattern to the target computer, wherein the transmitting is performed by a network terminal.

In order to accomplish the above object, the present invention provides a computer-readable recording medium in which a program for executing the method in a computer is recorded.

### Advantageous Effects

According to the present invention, a computer connected to a network is prevented from being waked-up by an unnecessary packet event, and remote wake-up of the computer is performed by a remote terminal connected to the network, if necessary. Thus, it is not required to continuously power-on a computer in order to satisfy external usage that cannot be predicted.

In addition, remote power-on used in a computer, which has a network adapter installed therein and supporting wake-up LAN (WOL) and supports an advanced configuration and power interface (ACPI), can be executed only under a LAN environment, and requires a separate hardware device on a WAN. However, according to the present invention, using a software method without the separate hardware device, a target computer connected to a network can be waked-up by a terminal connected to the network at a desired point of time, and the computer enters the sleep mode again even if the computer is inevitably waked-up due to an operating manner of the network.

### BRIEF DESCRIPTION OF DRAWINGS

FIG. 1 is a diagram of a system in which a method for remote wake-up is used, according to an embodiment of the present invention; and

FIG. 2 is a message sequence chart for explaining a method for remote wake-up, according to an embodiment of the present invention.

### BEST MODE FOR CARRYING OUT THE INVENTION

Hereinafter, the present invention will be described in detail by explaining exemplary embodiments of the invention with reference to the attached drawings.

Table 1 through 3 shows wake-up packet patterns that are generally defined. Table 1 shows an address resolution protocol (ARP) request packet (when an IP address is 172.16.22.12) pattern. Table 2 shows a unicast packet (when a MAC address is 08:00:46:4e:12:2e) pattern. In addition, Table 3 shows a NetBIOS name query packet (when a computer name is MiniVaio’) pattern.

TABLE 1
Byte Mask = { 00000000 00001100 00000100 00000000 00000011 11000000
}Pattern = { 00 00 00 00 00 00 00 00 00 00 00 00 08 06 00 00 00 00 00 00 00 01 00
00 00 00 00 00 00 00 00 00 00 00 00 00 00 00 ac 10 16 0c }

TABLE 2

Byte Mask = { 11111100 }Pattern = { 08 00 46 4e 12 2e }

TABLE 3
Byte Mask = { 00000000 00001100 00000001 00000000 00111100
0000010000000011 11111111 11111111 11111111 11111000 }Pattern = { 00 00 00
00 00 00 00 00 00 00 00 00 08 00 00 00 00 00 00 00 00 00 00 11 00 00 00 00 00 00
00 00 00 00 00 89 00 89 00 00 00 00 00 00 00 10 00 00 00 00 00 00 00 00 20 45 4e
45 4a 45 4f 45 4a 46 47 45 42 45 4a 45 50 43 41 43 41 43 41 43 41 43 41 43 41 43 41
}

The ARP request packet pattern shown in Table 1 is transmitted in the presence of a request for change in an IP address (172.16.22.12 in Table 1) of a system. That is, an ARP is used for a device connected to a network to recognize an Ethernet hardware address of another IP host network device on the network. At this time, the device connected to the network includes a computer. In this case, the device connected to the network may process the ARP request packet pattern in order to notify other devices on the network about the existence of the device. If not, the device may not be waked-up via the network.

When a computer connected to a network recognizes an Ethernet hardware address of the device, the ARP request packet may also be transmitted in order to check whether the device exists on the network. An example of the ARP request packet includes a packet for response/check request, which is periodically transmitted in order for an Internet service company to internally maintain and manage devices of the network. The packet for response/check request is not required for the computer connected to the network to keep notifying devices on the network about the existence of the computer. However, when a wake-up packet pattern is set to have a default value, if such an ARP response/check request packet is generated, the computer that enters a sleep mode may be waked-up. The ARP request packet for recognizing an Ethernet hardware address is different from the packet for the ARP response/check request on the ground that the ARP request packet and the packet for the ARP response/check request are transmitted in a broadcast method and a unicast method, respectively.

Thus, as shown in Table 4, when the wake-up packet pattern is limited to the ARP request packet that is transmitted in the broadcast method, the ARP response/check request packet is excluded from the wake-up packet pattern, thereby maintaining a sleep mode of the computer. Table 4 shows the case where an IP address is 172.16.22.12.

TABLE 4
Byte Mask = { 00000000 00001100 00000100 00000000 00000011 11000000
}Pattern = { ff ff ff ff ff ff 00 00 00 00 00 00 08 06 00 00 00 00 00 00 00 01 00 00 00
00 00 00 00 00 00 00 00 00 00 00 00 00 ac 10 16 0c }

As shown in Table 2, a unicast packet transmitted towards Ethernet hardware of a predetermined device is an example of the wake-up packet pattern that is defined by a system to have a default value. The unicast packet may also correspond to a packet transmitted in order for an Internet service company to internally maintain and manage devices of the network, or an unnecessary packet generated by software installed by another device on the network, and thus it is difficult to maintain a sleep mode of the device. On the other hand, when a network terminal selected by a user transmits a packet, the device may normally respond to the packet so as to be waked-up from the sleep mode. In order to achieve these, as shown in Table 5, a TCP packet (when an IP address is 172.16.22.18) transmitted from a predetermined network device may be set to be the wake-up packet pattern so that only the TCP packet pattern transmitted by the predetermined terminal corresponds to the wake-up packet pattern.

TABLE 5
Byte Mask = { 00000000 000001100 000000000 00111100 }Pattern = { 00 00 00 00
00 00 00 00 00 00 00 00 08 00 00 00 00 00 00 00 00 00 00 00 00 00 41 41 41 41 }

To achieve a general-purpose computer, a user may define a pattern between a network terminal and a computer, that is, a pattern that is sufficiently long and sufficiently complicated so as not to correspond to any packet from a predetermined offset, as a packet corresponding to the wake-up pattern, thereby simultaneously satisfying maintenance of the sleep mode and remote wake-up. For example, a starting IP address of a computer to which a remote wake-up packet may be indicated as an IP address of a computer in the wake-up pattern.

In addition, as shown in Table 3, the NetBIOS name query packet pattern includes a basic wake-up packet pattern. This is because response may be performed when the NetBIOS name query is requested. However, since a NetBIOS name is not required to wake-up a computer through a network, the NetBIOS name query packet pattern is also removed from a list of the wake-up packet pattern so that the computer may not be unnecessarily waked-up from a sleep mode.

When a network terminal having an IP address registered in a wake-up packet pattern shown in Table 5 transmits a packet to a target computer of a remote wake-up, or when a predetermine network terminal transmits a packet having a predetermined pattern with a predetermined length in a predetermined inner location to the target computer of remote wake-up computer, the target computer of remote wake-up is waked-up by a corresponding wake-up packet pattern. When an IP address of the target computer is removed from an ARP table cache of a gateway of the target computer, the gateway transmits an ARP request packet in broadcast. At this time, the target computer is also waked-up by a wake-up packet pattern set in the target computer. Thus, a computer connected to a network on WAN may be waked-up at a point of time desired by a user by using the wake-up packet patterns shown in Tables 4 and 5, while a mode of the computer is maintained to be a sleep mode.

However, when the ARP table cache of the gateway of the target computer disappears, if an unnecessary network packet is to be transmitted to the target computer, the gateway may also transmit the ARP request packet in broadcast, and thus the target computer is waked-up. This case is inevitable due to an operating manner of a network. In order to satisfy this case, software installed in the target computer monitors a wake-up event. Thus, when a network terminal selected by a user dose not transmit a packet, if the target computer is waked-up, the target computer is immediately set to enter a sleep mode, thereby minimizing power consumption. In this case, the target computer detects the case when the user presses a power switch, or manipulates a key board or a mouse. Thus, at this time, the target computer is set so as not to enter the sleep mode. Under an environment in which the target computer cannot detect such events, a communication window is displayed on a screen so as to ask the target computer to enter the sleep mode. Then, when a user does not input a user s input for a predetermined period of time (e.g., about 15 to about 30 seconds), it is deemed that the user does not manipulate an input device of the target computer, and then the target computer is set to be in the sleep mode.

The target computer may be inevitably waked-up due to an operating manner of a network. However, this case barely occurs as long as a packet related to hacking is blocked under a company environment or an environment connected to an Internet service provider (ISP), without P2P software or software receiving a packet from an unspecified network terminal such as a web server. In addition, this case occurs only when the ARP table cache of the gateway disappears. When this case occurs once, the ARP table cache is generated, and thus this case does not occur for a predetermined period of time. Thus, this case barely occurs.

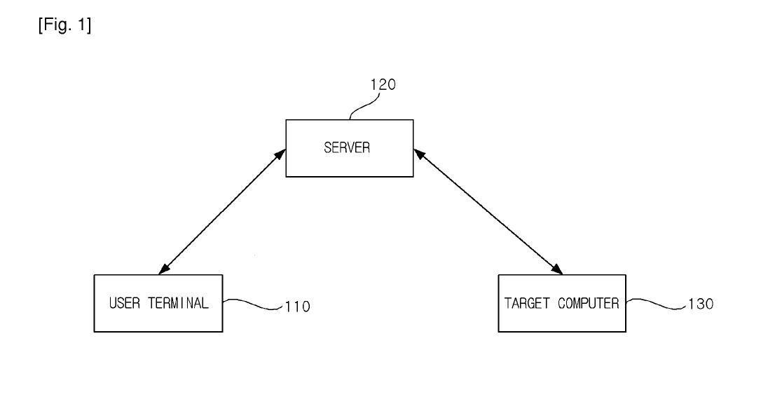

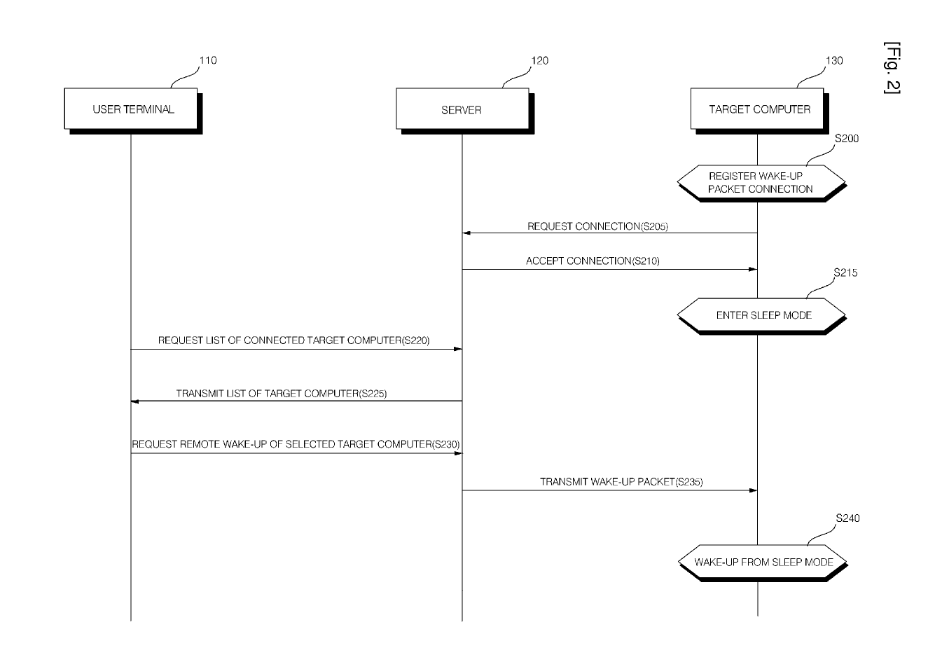

FIG. 1 is a diagram of a system in which a method for remote wake-up is used, according to an embodiment of the present invention. FIG. 2 is a message sequence chart for explaining a method for remote wake-up, according to an embodiment of the present invention. Referring to FIGS. 1 and 2, a user terminal 110 connected to a network such as a WAN wakes up a target computer 130 by remote wake-up by using the wake-up packet patterns shown in Tables 4 and 5, which will now be described.

Wake-up pattern set to have a default value is removed from the target computer 130. Then, the wake-up packets shown in Tables 4 and 5, that is, a broadcast ARP packet and an IP packet pattern having an IP address of a server 120 as a starting address are registered as a wake-up pattern (S200). When the target computer 130 requests a connection with the server 120, and the server 120 accepts the connection, the target computer 130 is connected to the server 120 (S205 and S210). The connection between the target computer 130 and the server 120 will be used as a path though which a wake-up packet for remote wake-up is transmitted. The order of the registering of the wake-up pattern and the connecting the target computer 130 to the server 120 may be reversed.

Then, the target computer 130 may automatically enter a sleep mode by a user s obvious command or previous settings of the target computer 130 (S215). A packet that does not correspond to the defined wake-up packet pattern is ignored, and thus the sleep mode is maintained according to a user s desire. Then, the user connects the user terminal 110 such as a computer connected to a WAN, a personal digital assistant (PDA) and a cellular phone to the server 120, and requests a list of target computers (S220). When the list of the target computers is transmitted to the user terminal 110 (S225), the user terminal 110 searches the list and selects a desired target computer, and then the user terminal 110 requests the server 120 for remote wake-up of the target computer (S230).

The server 120 transmits a wake-up packet to the target computer (S235). The wake-up packet is a predetermine packet having an IP address of the server 120 as a starting address, and may be a general TCP packet so as not to be deleted according to a packet filtering rule such as a gateway relaying a network connection between the server 120 and the target computer 130. When the wake-up packet is transmitted to the target computer 130, the target computer 130 is waked-up from the sleep mode (S240).

According to the present embodiment, since a connection between the server 120 and the target computer 130 is maintained, even if the target computer 130 is connected directly to the outside of the system including the target computer 130, or if the target computer 130 exists under an environment in which a packet cannot be transmitted without the connection, for example, under a NAT environment, the target computer 130 may be waked-up by remote wake-up. Thus, even if the target computer 130 is connected directly to the outside, or the target computer 130 exists under an environment in which a packet cannot be transmitted without the connection, a packet may be transmitted to the target computer 130 without the server 120.

So far, an environment that may be processed by the target computer 130 in order to notify other devices on a network about the existence of the target computer 130 has been described. However, the target computer 130 may process another protocol other than the ARP according to a network environment. In this case, the wake-up packet pattern shown in Table 4 may be replaced with and registered as a pattern of a corresponding protocol.

In addition, Tables 1 to 5 shows only examples of patterns. Thus, according to an operating system (OS) of the target computer 130 or the configuration of network software, various changes in form and details may be made therein without departing from the spirit and scope of the present invention as defined by the following claims.

The present invention can be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that computer-readable code is written thereto and executed therefrom in a decentralized manner.

### INDUSTRIAL APPLICABILITY

The present invention may be used to maintain a sleep mode of a computer connected to a network and to perform remote wake-up of the computer.

1. A method for remote wake-up of a computer connected to a network, the method comprising;
defining a wake-up packet pattern that simultaneously satisfies maintenance of the sleep mode and remote wake-up;
registering the wake-up pattern in a target computer; and
transmitting the wake-up packet pattern to the target computer, wherein the transmitting is performed by a network terminal.

2. The method of claim 1, wherein the wake-up packet pattern comprises any one of a broadcast address resolution protocol (ARP) request packet, an IP packet pattern in which an IP address of the network terminal is set, and a predetermined packet pattern defined between the network terminal and the target computer.

3. The method of claim 2, wherein the predetermined packet pattern defined between the network terminal and the target computer is a pattern that is sufficiently long and complicated so as not to correspond to any packet from a predetermined offset in a packet.

4. The method of claim 2, further comprising receiving the wake-up packet pattern so as to be waked-up from a sleep mode, wherein the receiving is performed in the target computer.

5. The method of claim 4, further comprising, when the wake-up packet pattern is not transmitted from a network terminal that is not selected by a user, entering the sleep mode.

6. The method of claim 4, further comprising:
displaying a communication window through which a user's input is input; and
when a user does not input the user's input through the communication window for a predetermined period of time, entering the sleep mode.

7. The method of claim 2, further comprising, for the network environment in which a protocol other than an ARP in order for the target computer to notify devices on a network about existence of the target computer,
defining and registering a pattern, which corresponds to the protocol corresponding to the network environment, performing logically the same function as that of the broadcast ARP request pattern as a new wake-up packet pattern.
